(19) United States
(12) Patent Application Publication
(10) Pub. No.: US 2026/0349649 A1
(43) Pub. Date: Nov. 5, 2026

(54) SOUND SIGNAL PROCESSING DEVICE AND SOUND SIGNAL PROCESSING PROGRAM

(71) Applicant: AlphaTheta Corporation, Yokohama-shi, Kanagawa (JP)

(72) Inventor: Kenta Sagawa, Yokohama-shi, Kanagawa (JP)

(21) Appl. No.: 19/486,190

(22) PCT Filed: May 25, 2023
(86) PCT No.: PCT/JP2023/019547

§ 371 Date: Nov. 20, 2025

(51) Int. Cl. G06F 3/16; H04R 3/04

(52) U.S. Cl. CPC G06F 3/165; H04R 3/04; H04R 2430/01

(57) ABSTRACT

An audio signal processing apparatus configured to adjust a volume of input audio data for each of a plurality of frequency bands, includes: a distribution unit (534) that distributes the input audio data into the frequency bands and outputs the distributed audio data to a first path and a second path; a first effect processing unit (536) included in the second path and configured to perform first effect processing of adding an audio effect or a special sound on the audio data distributed by the distribution unit; and a combining unit (537) that combines outputs of the volume adjustment units and an output of the first effect processing unit.

### TECHNICAL FIELD

The present invention relates to an audio signal processing apparatus and an audio signal processing program.

### BACKGROUND ART

In acoustic apparatuses such as mixers used for DJ performances, equalizer processing is known in which audio data is distributed into a plurality of frequency bands and the audio data is amplified or attenuated for each of the frequency bands.

For example, in a mixer described in Non-Patent Literature 1, equalizer processing is performed for three frequency bands of HI, MID, and LOW.

### CITATION LIST

### Non-Patent Literature(s)

Non-Patent Literature 1: DJM-900NXS2 User Manual (AlphaTheta Corporation), https://www.pioneerdj.com/ja-jp/support/documents/archive/ddj-sz/#manual

### SUMMARY OF THE INVENTION

### Problem(s) to be Solved by the Invention

In acoustic apparatuses, various kinds of effect processing, including equalizer processing, are performed.

An object of the invention is to provide an audio signal processing apparatus and an audio signal processing program capable of performing effect processing with enhanced effects through simple operations.

### Means for Solving the Problem(s)

An audio signal processing apparatus capable of adjusting a volume of input audio data for each of a plurality of frequency bands according to an aspect of the invention, includes: a distribution unit configured to distribute the input audio data into the frequency bands and output the distributed audio data to a first path and a second path; a first effect processing unit included in the second path and configured to perform first effect processing of adding an audio effect or a special sound on the audio data distributed by the distribution unit; and a combining unit configured to combine outputs of the volume adjustment units and an output of the first effect processing unit.

An audio signal processing program capable of adjusting a volume of input audio data for each of a plurality of frequency bands according to another aspect of the invention, includes: distributing the input audio data into the frequency bands and outputting the distributed audio data to a first path and a second path; performing first effect processing of adding an audio effect or a special sound on the audio data distributed to the second path; and combining the audio data amplified or attenuated for each of the frequency bands and the audio data on which the first effect processing has been performed.

### BRIEF DESCRIPTION OF DRAWINGS

FIG. 1 schematically illustrates a DJ mixer according to a first exemplary embodiment of the invention.

FIG. 2 is a diagram illustrating a volume adjuster according to the first exemplary embodiment of the invention.

FIG. 3 is another diagram illustrating the volume adjuster according to the first exemplary embodiment of the invention.

FIG. 4 illustrates a band-specific volume adjustment unit according to the first exemplary embodiment of the invention.

FIG. 5 is a diagram illustrating a first effect processing unit according to the first exemplary embodiment of the invention.

FIG. 6 is another diagram illustrating the first effect processing unit according to the first exemplary embodiment of the invention.

FIG. 7 illustrates a volume adjuster according to a second exemplary embodiment of the invention.

FIG. 8 is a diagram illustrating a second effect processing unit according to the second exemplary embodiment of the invention.

FIG. 9 is another diagram illustrating the second effect processing unit according to the second exemplary embodiment of the invention.

FIG. 10 illustrates a volume adjuster according to a third exemplary embodiment of the invention.

FIG. 11 is a functional block diagram of a control unit according to a fourth exemplary embodiment of the invention.

FIG. 12 is a flowchart illustrating operations of the control unit according to the fourth exemplary embodiment of the invention.

### DESCRIPTION OF EMBODIMENT(S)

Referring to the accompanying drawings, preferred exemplary embodiments of the invention will be described in detail below. It is to be noted that, in the specification and the accompanying drawings, duplicate descriptions are omitted by assigning the same reference numerals to components having substantially the same functional configuration.

### First Exemplary Embodiment

Referring to the drawings, an exemplary embodiment of the invention will be described below.

### Overall Configuration

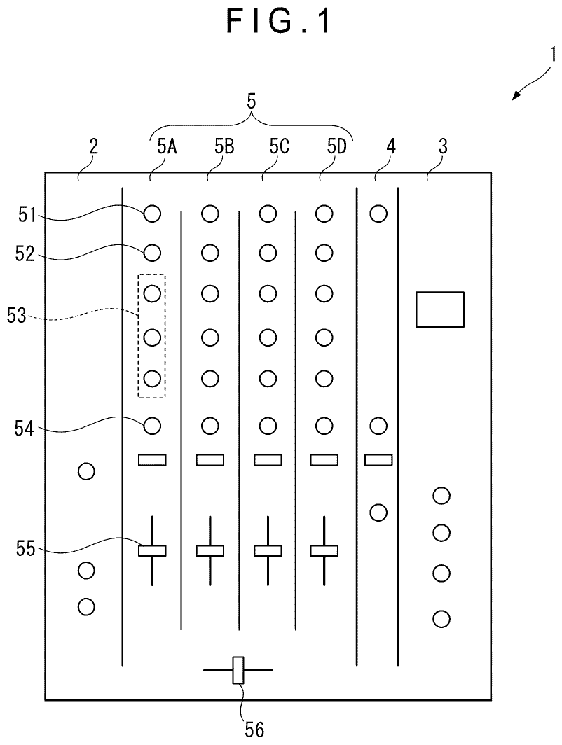

FIG. 1 schematically illustrates a DJ mixer 1 equipped with an audio signal processing apparatus according to a first exemplary embodiment of the invention. On the input side of the DJ mixer 1, although not illustrated, music playback apparatuses for reproducing music data, such as a vinyl record player, a CD player, and a computer, as well as music operation apparatuses such as a DJ controller, are connected. On the output side of the DJ mixer 1, acoustic apparatuses such as speakers are connected.

The DJ mixer 1 includes a microphone adjustment unit 2, an effect operating unit 3, a master adjustment unit 4, and an equalizer adjustment unit 5.

The microphone adjustment unit 2 includes operators for adjusting the output volume of a microphone (not illustrated) connected to the DJ mixer 1 and for starting and stopping effect processing with the effect operating unit 3. The microphone adjustment unit 2 further includes a terminal for connecting headphones, through which a user monitors the volume of audio data output from the DJ mixer 1. The microphone adjustment unit 2 includes, for example, a headphone input/output terminal, a headphone volume adjuster, a mixing adjuster, a master effect switcher and a master effect amount adjuster, a microphone switcher and a microphone volume adjuster, and a microphone equalizer adjuster.

The effect operating unit 3 includes operators for performing effect processing such as adding sound effects or audio effects to input audio data. The effect operating unit 3 further includes, for example, an effect operator, an effect switcher, a channel switcher, an effect time setter, and an effect amount adjuster.

The master adjustment unit 4 includes operators for adjusting the entirety of audio data to be output from the DJ mixer 1, the audio data having been subjected to effect processing and amplification. The master adjustment unit 4 includes, for example, a master volume adjuster, a level indicator, a master volume balance adjuster, an equalizer switcher, a channel fader switcher, and a crossfader switcher.

The equalizer adjustment unit 5 includes operators for performing equalizer processing on audio data input from music playback apparatuses connected to the DJ mixer 1, on a per-channel basis. Specifically, the equalizer adjustment unit 5 includes first to fourth adjustment units 5A to 5D for adjusting four channels.

The music playback apparatuses and the music operation apparatuses are respectively connected to the first to fourth adjustment units 5A to 5D, and equalizer adjustment can be performed for each of the adjustment units 5A to 5D. Each of the first to fourth adjustment units 5A to 5D includes an input switcher 51, an input channel volume adjuster 52, a volume adjuster 53, an effect adjuster 54, a channel fader 55, and a crossfader 56.

The input switcher 51 includes an operator for switching input sources of the music playback apparatuses and the music operation apparatuses connected to the DJ mixer 1. The input switcher 51 switches among connected apparatuses such as a vinyl record player connected to a phono jack of the DJ mixer 1, a CD player connected to a line jack, and a computer connected to a USB terminal.

The input channel volume adjuster 52 includes an operator for adjusting the input volume of the connected apparatus selected by the input switcher 51.

The volume adjuster 53 adjusts the volume of input audio data by amplifying or attenuating the data for each of a plurality of frequency bands. Details of the volume adjuster 53 will be described later.

The effect adjuster 54 adjusts an amount of effect, a depth of effect, that is, a degree of effect processing set in each of the first to fourth adjustment units 5A to 5D.

The channel fader 55 adjusts the volume output from each of the first to fourth adjustment units 5A to 5D.

### Detailed Configuration of Volume Adjuster 53

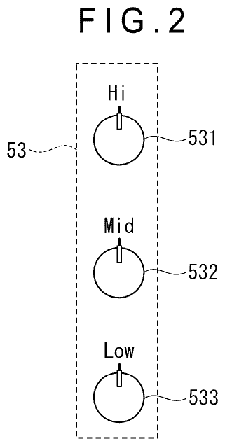

As illustrated in FIG. 2, the volume adjuster 53 includes an operation knob 531 for setting a volume adjustment amount of a high-frequency band, an operation knob 532 for setting a volume adjustment amount of a mid-frequency band, and an operation knob 533 for setting a volume adjustment amount of a low-frequency band.

Here, the high-frequency band is, for example, a frequency band of 4,649 Hz or higher. The mid-frequency band is, for example, a frequency band exceeding 284 Hz and lower than 4,649 Hz. The low-frequency band is, for example, a frequency band of 284 Hz or lower.

As illustrated in FIG. 2, the operation knobs 531, 532, and 533 are rotatably held on a housing of the volume adjuster 53.

The operation knob 531 for setting the volume adjustment amount of the high-frequency band, the operation knob 532 for setting the volume adjustment amount of the mid-frequency band, and the operation knob 533 for setting the volume adjustment amount of the low-frequency band are operable to rotate clockwise and counterclockwise.

By rotating the operation knobs 531, 532, and 533 clockwise, which is a plus direction, a user can adjust a volume adjustment amount of the corresponding frequency band in a direction in which audio data is amplified. By rotating the operation knobs 531, 532, and 533 counterclockwise, which is a minus direction, the user can adjust the volume adjustment amount of the corresponding frequency band in a direction in which the audio data is attenuated.

### Functional Block Diagram of Volume Adjuster 53

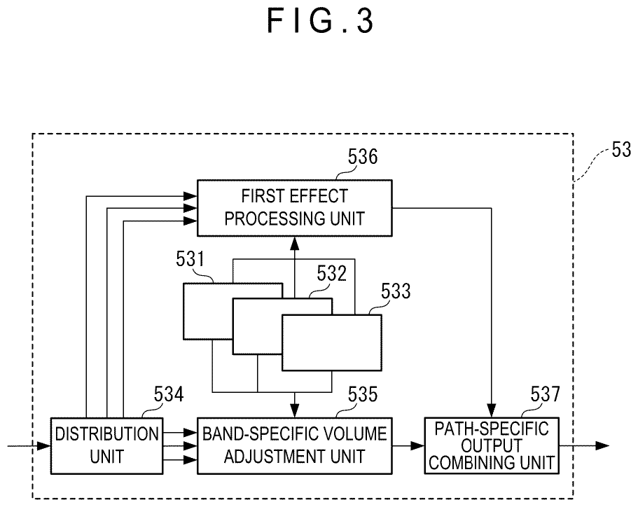

FIG. 3 illustrates a functional block diagram of the volume adjuster 53.

The volume adjuster 53 includes a distribution unit 534, a band-specific volume adjustment unit 535, a first effect processing unit 536, and a path-specific output combining unit 537.

The distribution unit 534 distributes audio data input to the volume adjuster 53 into a plurality of frequency bands. The frequency bands are, for example, the three frequency bands of the high-frequency band, the mid-frequency band, and the low-frequency band described above.

As illustrated in FIG. 3, outputs of the distribution unit 534 are supplied to both the band-specific volume adjustment unit 535 and the first effect processing unit 536. In other words, the distribution unit 534 of the volume adjuster 53 distributes the outputs to a first path including the band-specific volume adjustment unit 535 and a second path including the first effect processing unit 536.

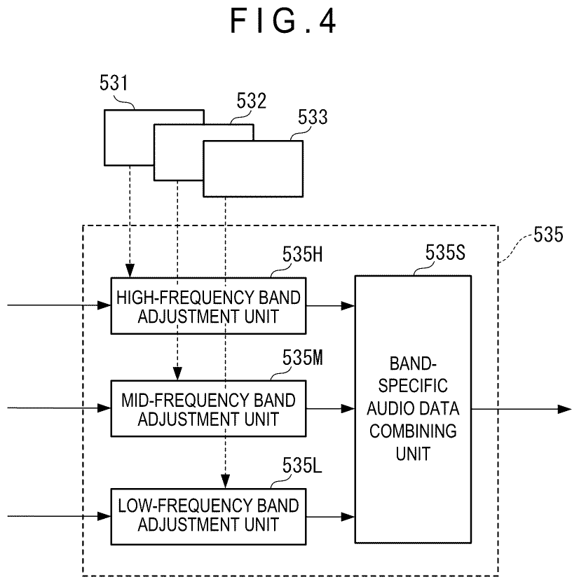

As illustrated in FIG. 4, the band-specific volume adjustment unit 535 includes a high-frequency band adjustment unit 535H, a mid-frequency band adjustment unit 535M, a low-frequency band adjustment unit 535L, and a band-specific audio data combining unit 535S.

The high-frequency band adjustment unit 535H adjusts the volume of the high-frequency band by amplifying or attenuating high-frequency band audio data among the audio data distributed by the distribution unit 534, according to the volume adjustment amount set by the operation knob 531 for setting the volume adjustment amount of the high-frequency band.

Similarly, the mid-frequency band adjustment unit 535M adjusts the volume of the mid-frequency band by amplifying or attenuating mid-frequency band audio data among the audio data distributed by the distribution unit 534, according to the volume adjustment amount set by the operation knob 532 for setting the volume adjustment amount of the mid-frequency band. The low-frequency band adjustment unit 535L adjusts the volume of the low-frequency band by amplifying or attenuating low-frequency band audio data among the audio data distributed by the distribution unit 534, according to the volume adjustment amount set by the operation knob 533 for setting the volume adjustment amount of the low-frequency band.

As illustrated in FIG. 4, the band-specific audio data combining unit 535S combines outputs of the high-frequency band adjustment unit 535H, the mid-frequency band adjustment unit 535M, and the low-frequency band adjustment unit 535L. An output of the band-specific audio data combining unit 535S is supplied, as an output of the band-specific volume adjustment unit 535, to the path-specific output combining unit 537 as illustrated in FIG. 3.

The first effect processing unit 536 performs first effect processing for adding audio effects or special sounds to the audio data distributed by the distribution unit 534. Here, the effects performed by the first effect processing unit 536 are effects additionally applied to original sounds of the audio data, having characteristics such as emphasizing or highlighting the audio data, increasing its speed, or giving it a stronger impression or brilliance. For example, echo, reverb-up, and spiral-up effects are performed by the first effect processing unit 536.

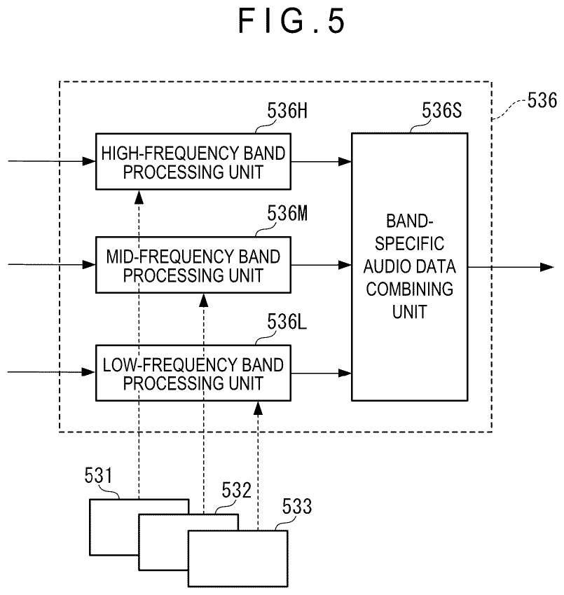

FIG. 5 illustrates an example of the first effect processing unit 536. As illustrated in FIG. 5, the first effect processing unit 536 includes a high-frequency band processing unit 536H, a mid-frequency band processing unit 536M, a low-frequency band processing unit 536L, and a band-specific audio data combining unit 536S.

The high-frequency band processing unit 536H performs the first effect processing on high-frequency band audio data among the audio data distributed by the distribution unit 534, according to the volume adjustment amount set by the operation knob 531 for setting the volume adjustment amount of the high-frequency band.

Similarly, the mid-frequency band processing unit 536M performs the first effect processing on mid-frequency band audio data among the audio data distributed by the distribution unit 534, according to the volume adjustment amount set by the operation knob 532 for setting the volume adjustment amount of the mid-frequency band. The low-frequency band processing unit 536L performs the first effect processing on low-frequency band audio data among the audio data distributed by the distribution unit 534, according to the volume adjustment amount set by the operation knob 533 for setting the volume adjustment amount of the low-frequency band.

As illustrated in FIG. 5, the band-specific audio data combining unit 536S combines outputs of the high-frequency band processing unit 536H, the mid-frequency band processing unit 536M, and the low-frequency band processing unit 536L. An output of the band-specific audio data combining unit 536S is supplied, as an output of the first effect processing unit 536, to the path-specific output combining unit 537 as illustrated in FIG. 3.

In the example of FIG. 5, each of the high-frequency band processing unit 536H, the mid-frequency band processing unit 536M, and the low-frequency band processing unit 536L may change a degree of the first effect processing according to the volume adjustment amount set by the corresponding one of the operation knobs 531, 532, and 533, or may switch whether or not to perform the first effect processing according to the volume adjustment amount. For example, the configuration may be such that the first effect processing is not performed when the set volume adjustment amount is less than a predetermined threshold, and the first effect processing is performed when the set volume adjustment amount is equal to or greater than the predetermined threshold. In addition, for example, the configuration may be such that the first effect processing is performed when the set volume adjustment amount indicates a direction to amplify audio data, and the first effect processing is not performed when the set volume adjustment amount indicates a direction to attenuate audio data.

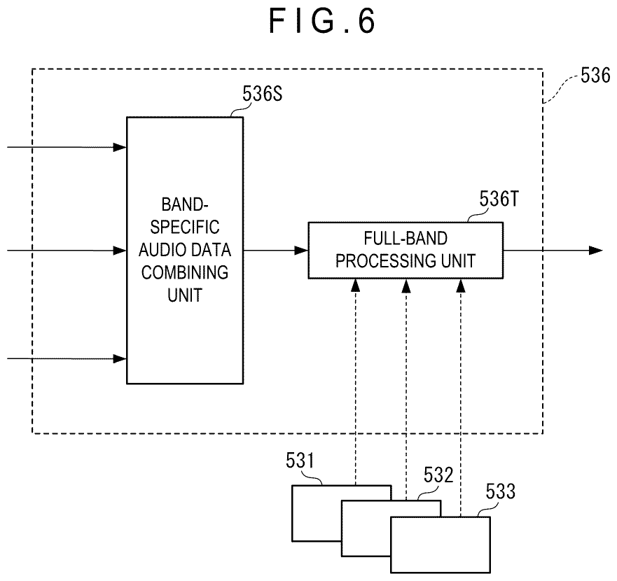

FIG. 6 illustrates another example of the first effect processing unit 536. As illustrated in FIG. 6, the first effect processing unit 536 includes the band-specific audio data combining unit 536S and a full-band processing unit 536T.

The band-specific audio data combining unit 536S combines the audio data distributed by the distribution unit 534 and supplies the combined audio data to the full-band processing unit 536T.

The full-band processing unit 536T performs the first effect processing on the audio data combined by the band-specific audio data combining unit 536S, according to the volume adjustment amounts set by the operation knobs 531, 532, and 533.

An output of the full-band processing unit 536T is supplied, as an output of the first effect processing unit 536, to the path-specific output combining unit 537 as illustrated in FIG. 3.

In the example of FIG. 6, the full-band processing unit 536T may comprehensively determine or selectively refer to the volume adjustment amounts set by the respective operation knobs 531, 532, and 533, and may change a degree of the first effect processing, or may switch whether or not to perform the first effect processing according to each of the volume adjustment amounts. For example, the configuration may be such that the first effect processing is not performed when the set volume adjustment amount is less than a predetermined threshold, and the first effect processing is performed when the set volume adjustment amount is equal to or greater than the predetermined threshold. In addition, for example, the configuration may be such that the first effect processing is performed when the set volume adjustment amount indicates a direction to amplify audio data, and the first effect processing is not performed when the set volume adjustment amount indicates a direction to attenuate audio data.

The path-specific output combining unit 537 combines the output of the band-specific volume adjustment unit 535 included in the first path and the output of the first effect processing unit 536 included in the second path.

According to the volume adjuster 53 described above, when a user adjusts the operation knobs 531, 532, and 533 for setting the volume adjustment amounts for the respective frequency bands, not only are volumes adjusted for the respective frequency bands, but also the first effect processing corresponding to tendencies or degrees of the volume adjustments is performed, and audio effects or special sounds are added.

Whether or not processing by the first effect processing unit 536 is performed in the volume adjuster 53 may be automatically switched according to predetermined conditions, or may be switched by a user. That is, in the volume adjuster 53, the configuration may be such that a first mode in which the outputs of the distribution unit 534 are used only in the first path including the band-specific volume adjustment unit 535 and a second mode in which, in addition to the first path, the outputs of the distribution unit 534 are also used in the second path including the first effect processing unit 536 are switchable.

### Effects of First Exemplary Embodiment

According to the first exemplary embodiment of the invention described above, the following effects can be achieved.

The DJ mixer 1 is capable of adjusting a volume of input audio data for each of a plurality of frequency bands. The DJ mixer 1 includes: the distribution unit 534 that distributes the input audio data into the frequency bands and outputs the distributed audio data to the first path and the second path; the first effect processing unit 536 that is included in the second path and performs the first effect processing of adding audio effects or special sounds on the audio data distributed by the distribution unit 534; and the path-specific output combining unit 537 that combines an output obtained by combining outputs of the high-frequency band adjustment unit 535H, the mid-frequency band adjustment unit 535M, and the low-frequency band adjustment unit 535L, and an output of the first effect processing unit 536.

According to such a configuration, the first effect processing is additionally performed when adjusting volumes for the respective frequency bands. It is thus possible to perform effect processing with enhanced effects through simple operations.

According to the first exemplary embodiment, the DJ mixer 1 further includes the operation knobs 531, 532, and 533, which are a plurality of setters for setting the volume adjustment amounts for the respective frequency bands, and the high-frequency band adjustment unit 535H, the mid-frequency band adjustment unit 535M, and the low-frequency band adjustment unit 535L, which are a plurality of volume adjustment units included in the first path and amplify or attenuate audio data for the respective frequency bands according to the adjustment amounts set for the respective frequency bands.

According to such a configuration, when the operation knobs 531, 532, and 533 for setting the volume adjustment amounts for the respective frequency bands are adjusted, not only are volumes adjusted for the respective frequency bands, but also the first effect processing is additionally performed, and audio effects or special sounds are added to original sounds whose volumes have been adjusted. It is thus possible to perform effect processing corresponding to the volume adjustments through simple operations.

According to the first exemplary embodiment, the first effect processing unit 536 performs the first effect processing for the respective frequency bands. Therefore, by performing the first effect processing on a frequency band to be emphasized through volume adjustment and additionally combining it with the original sound whose volume has been adjusted, the volume can be adjusted to provide a tone having further distinctive characteristics.

According to the first exemplary embodiment, the first effect processing unit 536 performs the first effect processing for the respective frequency bands according to the adjustment amounts set respectively by the operation knobs 531, 532, and 533, which are the setters. It is thus possible to perform the first effect processing corresponding to tendencies or degrees of volume adjustments.

### Second Exemplary Embodiment

In a second exemplary embodiment, only parts different from the first exemplary embodiment will be described, and descriptions of parts similar to those of the first exemplary embodiment will be omitted.

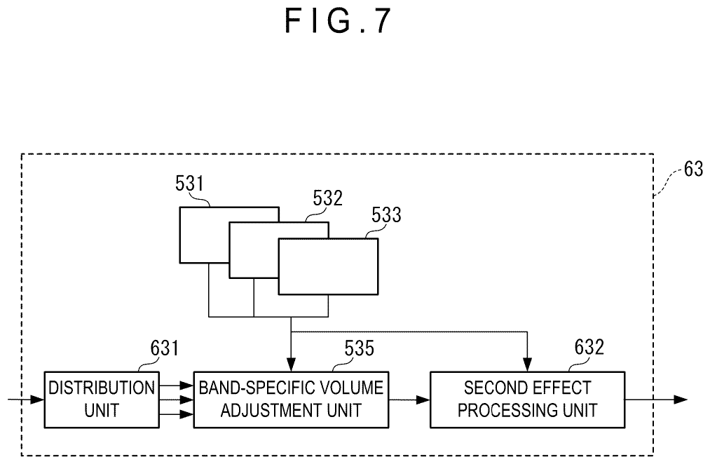

A DJ mixer according to the second exemplary embodiment includes, instead of the volume adjuster 53 of the DJ mixer 1 of the first exemplary embodiment, a volume adjuster 63 illustrated in FIG. 7.

The volume adjuster 63 includes, similarly to the first exemplary embodiment, the operation knob 531 for setting a volume adjustment amount of the high-frequency band, the operation knob 532 for setting a volume adjustment amount of the mid-frequency band, the operation knob 533 for setting a volume adjustment amount of the low-frequency band, and the band-specific volume adjustment unit 535. The volume adjuster 63 further includes a distribution unit 631 instead of the distribution unit 534 of the first exemplary embodiment, and a second effect processing unit 632 instead of the path-specific output combining unit 537.

The distribution unit 631, similarly to the volume adjuster 53 of the first exemplary embodiment, distributes input audio data into a plurality of frequency bands.

Outputs of the distribution unit 631 are supplied only to the band-specific volume adjustment unit 535 as illustrated in FIG. 7. That is, the volume adjuster 63 includes only a first path including the band-specific volume adjustment unit 535 and the second effect processing unit 632.

The second effect processing unit 632 performs second effect processing of adding audio effects or special sounds on audio data whose volumes have been adjusted by the band-specific volume adjustment unit 535. Here, the effects performed by the second effect processing unit 632 are effects different from those performed by the first effect processing unit 536. The effects performed by the second effect processing unit 632 are effects applied to the original sounds themselves of the audio data, having characteristics such as softening or muffling the sound of the audio data, reducing its speed, weakening its impression, or making it less noticeable. For example, effects such as reverb-down and spiral-down, and filter processing are performed by the second effect processing unit 632.

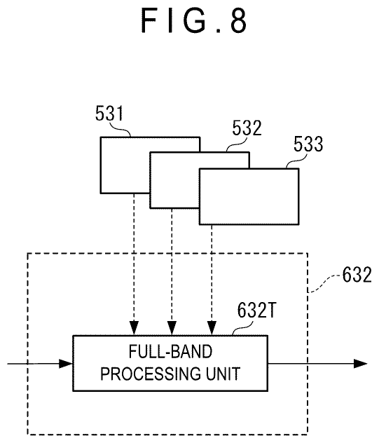

FIG. 8 illustrates an example of the second effect processing unit 632. As illustrated in FIG. 8, the second effect processing unit 632 includes a full-band processing unit 632T.

The full-band processing unit 632T performs the second effect processing according to the volume adjustment amounts set by the operation knobs 531, 532, and 533.

An output of the full-band processing unit 632T is output, as an output of the second effect processing unit 632, from the volume adjuster 63 as illustrated in FIG. 7.

In the example of FIG. 8, the full-band processing unit 632T may comprehensively determine or selectively refer to the volume adjustment amounts set by the respective operation knobs 531, 532, and 533, and may change a degree of the second effect processing, or may switch whether or not to perform the second effect processing according to each of the volume adjustment amounts. For example, the configuration may be such that the second effect processing is not performed when the set volume adjustment amount is equal to or greater than a predetermined threshold, and the second effect processing is performed when the set volume adjustment amount is less than the predetermined threshold. In addition, for example, the configuration may be such that the second effect processing is performed when the set volume adjustment amount indicates a direction to attenuate audio data, and the second effect processing is not performed when the set volume adjustment amount indicates a direction to amplify audio data.

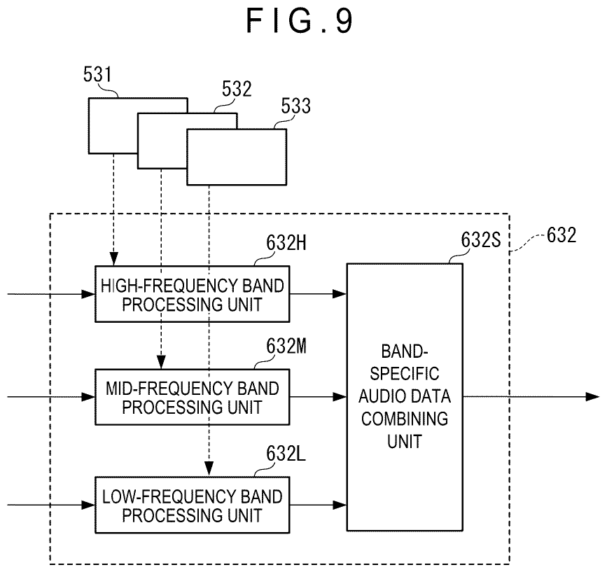

FIG. 9 illustrates another example of the second effect processing unit 632.

As described with reference to FIG. 4 in the first exemplary embodiment, the example is given in which the band-specific volume adjustment unit 535 performs adjustments for the respective frequency bands and combines the respective outputs. However, when the band-specific volume adjustment unit 535 outputs audio data for the respective frequency bands before combination, the second effect processing unit 632 may include, as illustrated in FIG. 9, a high-frequency band processing unit 632H, a mid-frequency band processing unit 632M, a low-frequency band processing unit 632L, and a band-specific audio data combining unit 632S.

The high-frequency band processing unit 632H performs the second effect processing on high-frequency band audio data whose volume has been adjusted by the band-specific volume adjustment unit 535, according to the volume adjustment amount set by the operation knob 531 for setting the volume adjustment amount of the high-frequency band.

Similarly, the mid-frequency band processing unit 632M performs the second effect processing on mid-frequency band audio data whose volume has been adjusted by the band-specific volume adjustment unit 535, according to the volume adjustment amount set by the operation knob 532 for setting the volume adjustment amount of the mid-frequency band. The low-frequency band processing unit 632L performs the second effect processing on low-frequency band audio data whose volume has been adjusted by the band-specific volume adjustment unit 535, according to the volume adjustment amount set by the operation knob 533 for setting the volume adjustment amount of the low-frequency band.

As illustrated in FIG. 9, the band-specific audio data combining unit 632S combines outputs of the high-frequency band processing unit 632H, the mid-frequency band processing unit 632M, and the low-frequency band processing unit 632L. An output of the band-specific audio data combining unit 632S is output, as an output of the second effect processing unit 632, from the volume adjuster 63 as illustrated in FIG. 7.

In the example of FIG. 9, each of the high-frequency band processing unit 632H, the mid-frequency band processing unit 632M, and the low-frequency band processing unit 632L may change a degree of the second effect processing according to the volume adjustment amount set by the corresponding one of the operation knobs 531, 532, and 533, or may switch whether or not to perform the second effect processing according to the volume adjustment amount. For example, the configuration may be such that the second effect processing is not performed when the set volume adjustment amount is equal to or greater than a predetermined threshold, and the second effect processing is performed when the set volume adjustment amount is less than the predetermined threshold. In addition, for example, the configuration may be such that the second effect processing is performed when the set volume adjustment amount indicates a direction to attenuate audio data, and the second effect processing is not performed when the set volume adjustment amount indicates a direction to amplify audio data.

According to the volume adjuster 63 described above, when a user adjusts the operation knobs 531, 532, and 533 for setting the volume adjustment amounts for the respective frequency bands, not only are volumes adjusted for the respective frequency bands, but also the second effect processing corresponding to tendencies or degrees of the volume adjustments is performed on audio data whose volumes have been adjusted.

In the volume adjuster 63, whether or not processing by the second effect processing unit 632 is performed may be automatically switched according to predetermined conditions, or may be switched by a user. That is, in the volume adjuster 63, the configuration may be such that a first mode in which processing by the second effect processing unit 632 is not performed and a second mode in which processing by the second effect processing unit 632 is performed are switchable.

### Effects of Second Exemplary Embodiment

According to the second exemplary embodiment of the invention described above, provided is the second effect processing unit 632 that is different from the first effect processing unit 536 and performs the second effect processing on the audio data amplified or attenuated by the high-frequency band adjustment unit 535H, the mid-frequency band adjustment unit 535M, and the low-frequency band adjustment unit 535L, which are the volume adjustment units.

According to such a configuration, when the operation knobs 531, 532, and 533 for setting the volume adjustment amounts for the respective frequency bands are adjusted, the second effect processing is performed on the audio data whose volumes have been adjusted for the respective frequency bands, and audio effects or special sounds are added. Therefore, effect processing with enhanced effects can be achieved through simple operations.

According to the second exemplary embodiment of the invention, the second effect processing unit 632 performs the second effect processing on the audio data amplified or attenuated for each of the frequency bands. Therefore, by performing the second effect processing on the original sounds of the respective frequency bands whose volumes have been adjusted, the volumes can be adjusted to provide tones having further distinctive characteristics.

According to the second exemplary embodiment of the invention, the second effect processing unit 632 performs the second effect processing for the respective frequency bands according to the adjustment amounts set by the operation knobs 531, 532, and 533, which are the setters. It is thus possible to perform the second effect processing corresponding to tendencies or degrees of volume adjustments.

### Third Exemplary Embodiment

In a third exemplary embodiment, only the parts that are different from the first and second exemplary embodiments will be described, and the description of the parts that are the same as those in the first and second exemplary embodiments will be omitted.

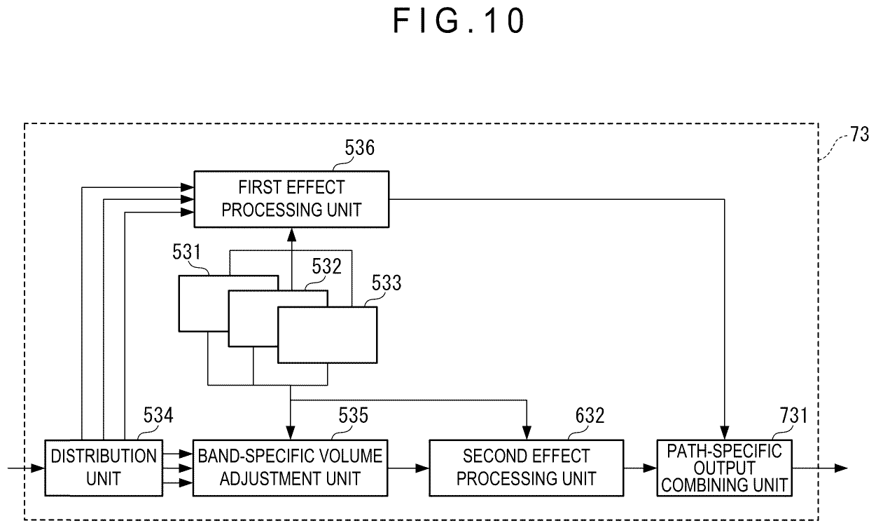

A DJ mixer according to the third exemplary embodiment has a configuration in which the DJ mixer of the first exemplary embodiment and the DJ mixer of the second exemplary embodiment are combined. The DJ mixer according to the third exemplary embodiment includes, instead of the volume adjuster 53 of the DJ mixer 1 of the first exemplary embodiment, a volume adjuster 73 illustrated in FIG. 10.

The volume adjuster 73 includes, similarly to the first exemplary embodiment, the operation knob 531 for setting a volume adjustment amount of the high-frequency band, the operation knob 532 for setting a volume adjustment amount of the mid-frequency band, the operation knob 533 for setting a volume adjustment amount of the low-frequency band, the distribution unit 534, the band-specific volume adjustment unit 535, and the first effect processing unit 536. Further, the volume adjuster 73 includes, instead of the path-specific output combining unit 537 of the first exemplary embodiment, a path-specific output combining unit 731, and includes, similarly to the second exemplary embodiment, the second effect processing unit 632.

The distribution unit 534 of the volume adjuster 73 distributes outputs to a first path including the band-specific volume adjustment unit 535 and the second effect processing unit 632, and to a second path including the first effect processing unit 536.

As illustrated in FIG. 10, the path-specific output combining unit 731 combines the output of the first effect processing unit 536 and the output of the second effect processing unit 632.

### Effects of Third Exemplary Embodiment

According to the third exemplary embodiment of the invention described above, effects obtained by combining the effects of the first exemplary embodiment and the second exemplary embodiment can be achieved.

### Fourth Exemplary Embodiment

In a fourth exemplary embodiment, only the parts that are different from the first to third exemplary embodiments will be described, and the description of the parts that are the same as those in the first to third exemplary embodiments will be omitted.

A DJ mixer according to the fourth exemplary embodiment has a configuration in which processing by the volume adjuster 53 of the first exemplary embodiment is executed by software.

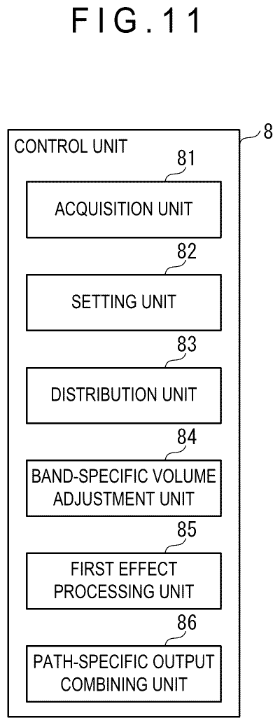

FIG. 11 is a functional block diagram of a control unit of the DJ mixer according to the fourth exemplary embodiment. As illustrated in FIG. 11, a control unit 8 includes an acquisition unit 81, a setting unit 82, a distribution unit 83, a band-specific volume adjustment unit 84, a first effect processing unit 85, and a path-specific output combining unit 86. Functions of these units are implemented, for example, in an acoustic apparatus having a hardware configuration of a computer, by a processor operating in accordance with a program.

The acquisition unit 81 acquires audio data and outputs of various operators of the DJ mixer 1.

The setting unit 82 sets volume adjustment amounts based on outputs of the operation knobs 531, 532, and 533.

The distribution unit 83, similarly to the distribution unit 534 of the first exemplary embodiment, distributes input audio data into a plurality of frequency bands.

Similarly to the band-specific volume adjustment unit 535 of the first exemplary embodiment, the band-specific volume adjustment unit 84 adjusts the volume for each of the frequency bands by amplifying or attenuating the audio data of the frequency band according to the volume adjustment amount set by the corresponding one of the operation knobs 531, 532, and 533.

Similarly to the first effect processing unit 536 of the first exemplary embodiment, the first effect processing unit 85 performs the first effect processing of adding audio effects or special sounds on the audio data distributed by the distribution unit 83.

Similarly to the path-specific output combining unit 537 of the first exemplary embodiment, the path-specific output combining unit 86 combines an output of the band-specific volume adjustment unit 84 and an output of the first effect processing unit 85.

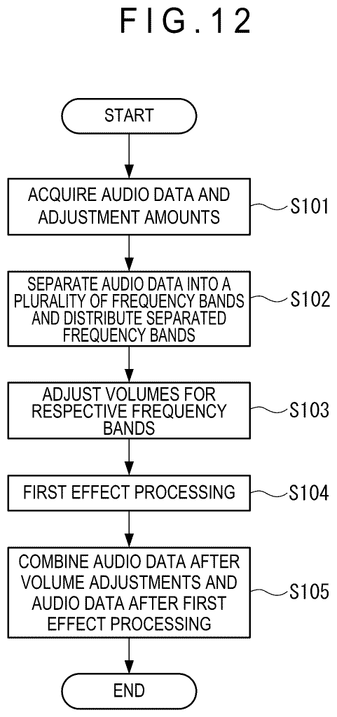

Next, operations of the control unit 8 in the fourth exemplary embodiment will be described with reference to the flowchart of FIG. 12.

The acquisition unit 81 acquires audio data and adjustment amounts (step S101), and the distribution unit 83 distributes the audio data into a plurality of frequency bands (step S102).

Then, the band-specific volume adjustment unit 84 adjusts volumes of the audio data distributed by the distribution unit 83 for the respective frequency bands (step S103), and the first effect processing unit 85 performs the first effect processing on the audio data distributed by the distribution unit 83 (step S104).

Further, the path-specific output combining unit 86 combines an output of the band-specific volume adjustment unit 84 and an output of the first effect processing unit 85 (step S105).

The processing by the volume adjuster 63 of the second exemplary embodiment and the processing by the volume adjuster 73 of the third exemplary embodiment can also be executed by software in a similar manner.

### Effects of Fourth Exemplary Embodiment

According to the fourth exemplary embodiment of the invention described above, configurations similar to those of the first to third exemplary embodiments can be implemented by software.

### Modifications of Exemplary Embodiments

Each of the exemplary embodiments of the invention described above is an example, and various modifications are possible. For example, in each of the exemplary embodiments described above, the DJ mixer has been exemplified as an acoustic apparatus, but similar functions can be implemented in other DJ equipment such as controllers or all-in-one DJ systems (digital audio players with communication and mixing functions). The above functions can also be implemented by a DJ application in terminal devices such as PCs or smart phones.

In each of the exemplary embodiments described above, the four-channel acoustic apparatus has been described, but for example, similar functions can also be achieved in a two-channel acoustic apparatus.

The invention is not limited to applications in DJ equipment, and can also be applied to general mixers, electronic musical instruments, and further to acoustic apparatuses such as Digital Audio Workstation (DAW) and Desk Top Music (DTM).

As described above in detail with reference to the accompanying drawings, preferred exemplary embodiments of the invention have been explained, but the invention is not limited to these examples. It will be apparent to those skilled in the art of the technical field to which the invention pertains that various modifications or alterations may be conceived within the scope of the technical idea recited in the claims, and such modifications or alterations are of course to be understood as belonging to the technical scope of the invention.

### Outline of the Invention

[1] An audio signal processing apparatus capable of adjusting a volume of input audio data for each of a plurality of frequency bands, the apparatus including: a distribution unit configured to distribute the input audio data into the frequency bands and to output the distributed audio data to a first path and a second path; a first effect processing unit included in the second path and configured to perform first effect processing of adding an audio effect or a special sound on the audio data distributed by the distribution unit; and a combining unit configured to combine outputs of a plurality of volume adjustment units and an output of the first effect processing unit.
[2] The audio signal processing apparatus according to [1], including: a plurality of setters configured to set volume adjustment amounts for the respective frequency bands; and a plurality of volume adjustment units included in the first path and configured to amplify or attenuate the audio data distributed by the distribution unit according to the adjustment amounts set respectively by the setters for the respective frequency bands.
[3] The audio signal processing apparatus according to [1] or [2], in which the first effect processing unit is configured to perform the first effect processing on the audio data distributed by the distribution unit for each of the frequency bands.
[4] The audio signal processing apparatus according to [2] or [3], in which the first effect processing unit is configured to perform the first effect processing for the respective frequency bands according to the adjustment amounts set respectively by the setters.
[5] The audio signal processing apparatus according to any one of [2] to [4], further including a second effect processing unit that is different from the first effect processing unit and configured to perform second effect processing on the audio data amplified or attenuated by the volume adjustment units.
[6] The audio signal processing apparatus according to [5], in which the second effect processing unit is configured to perform the second effect processing on the audio data amplified or attenuated by the volume adjustment units for the respective frequency bands.
[7] The audio signal processing apparatus according to [6], in which the second effect processing unit is configured to perform the second effect processing for the respective frequency bands according to the adjustment amounts set respectively by the setters.
[8] An audio signal processing program capable of adjusting a volume of input audio data for each of a plurality of frequency bands, the program including:
   setting volume adjustment amounts for the respective frequency bands;
   distributing the input audio data into the frequency bands; amplifying or attenuating the distributed audio data for the respective frequency bands according to the adjustment amounts set respectively; performing first effect processing of adding an audio effect or a special sound on the distributed audio data; and combining the audio data amplified or attenuated for the respective frequency bands and the audio data on which the first effect processing has been performed.

### EXPLANATION OF CODES

1 . . . DJ mixer, 2 . . . microphone adjustment unit, 3 . . . effect operating unit, 4 . . . master adjustment unit, 5 . . . equalizer adjustment unit, 5A . . . first adjustment unit, 5D . . . fourth adjustment unit, 8 . . . control unit, 51 . . . input switcher, 52 . . . input channel volume adjuster, 53, 63, 73 . . . volume adjuster, 54 . . . effect adjuster, 55 . . . channel fader, 56 . . . crossfader, 81 . . . acquisition unit, 82 . . . setting unit, 83, 534, 631 . . . distribution unit, 84, 535 . . . band-specific volume adjustment unit, 85, 536 . . . first effect processing unit, 86, 537, 731 . . . path-specific output combining unit, 535S, 536S, 632S . . . band-specific audio data combining unit, 531, 532, 533 . . . operation knob, 632 . . . second effect processing unit

1.-8. (canceled)

9. An audio signal processing apparatus configured to adjust a volume of input audio data for each of a plurality of frequency bands, the apparatus comprising:
a distribution unit configured to separate the input audio data into the frequency bands and distribute the separated frequency bands to a first path and a second path;
a first effect processing unit included in the second path and configured to perform first effect processing of adding an audio effect or a special sound on the audio data for the separated frequency bands distributed by the distribution unit; and
a combining unit configured to combine an output from the first path and an output fromt the first effect processing unit.

10. The audio signal processing apparatus according to claim 9, comprising:
a plurality of setters configured to set volume adjustment amounts for the respective frequency bands; and
a plurality of volume adjustment units included in the first path and configured to amplify or attenuate the respective frequency bands separated by the distribution unit according to the adjustment amounts set respectively by the setters.

11. The audio signal processing apparatus according to claim 9, wherein the first effect processing unit is configured to perform the first effect processing on the audio data for the separated frequency bands distributed by the distribution unit for each of the frequency bands.

12. The audio signal processing apparatus according to claim 10, wherein the first effect processing unit is configured to perform the first effect processing for the respective frequency bands according to the adjustment amounts set respectively by the setters.

13. The audio signal processing apparatus according to claim 10, further comprising a second effect processing unit configured to perform second effect processing on the audio data for the separated frequency bands amplified or attenuated by the volume adjustment units, the second effect processing being different from the first effect processing.

14. The audio signal processing apparatus according to claim 13, wherein the second effect processing unit is configured to perform the second effect processing on the audio data for the separated frequency bands amplified or attenuated by the volume adjustment units, for each of the frequency bands.

15. The audio signal processing apparatus according to claim 14, wherein the second effect processing unit is configured to perform the second effect processing for the respective frequency bands according to the adjustment amounts set respectively by the setters.

16. A non-transitory computer-readable medium storing an audio signal processing program executed by a computer to adjust a volume of input audio data for each of a plurality of frequency bands, the program causing the computer to:
separate the input audio data into the frequency bands and distribute the separated frequency bands to a first path and a second path;
perform first effect processing of adding an audio effect or a special sound on the audio data for the separated frequency bands distributed to the second path; and
combine the audio data amplified or attenuated for each of the frequency bands and the audio data on which the first effect processing has been performed.
